(19) United States
(12) Patent Application Publication
(10) Pub. No.: US 2008/0159476 A1
(43) Pub. Date: Jul. 3, 2008

(54) GEIGER-MULLER TUBE-BASED SYSTEM AND METHOD FOR RADIATION DETECTION

(75) Inventors: David S. Koltick, Lafayette, IN (US); Ivan S. Novikov, Nashville, TN (US); Howard M. Harmless, Indianapolis, IN (US)

Correspondence Address: HARTMAN & HARTMAN, P.C., 552 EAST 700 NORTH, VALPARAISO, IN, 46383, US

(73) Assignee: Purdue Research Foundation, West Lafayette, IN (US)

(21) Appl. No.: 11/968,807

(22) Filed: Jan. 3, 2008

Related U.S. Application Data
(60) Provisional application No. 60/883,250, filed on Jan. 3, 2007.

(51) Int. Cl. G01N 23/06

(52) U.S. Cl. 378/53

(57) ABSTRACT

A system and method suitable for detecting radiation in a flowing liquid, such as a water flowing in a water supply system. The system includes a closed tubular-shaped container having a hollow interior that contains an inert gas at an elevated pressure, and a tubular-shaped housing surrounding the container. The container has a wall structure comprising a cathode, and has an inner electrical element within its hollow interior that defines an anode along a longitudinal axis of the container. The housing has an inlet and an outlet at oppositely-disposed ends thereof, and the container and housing cooperate to define a flow passage generally parallel to the longitudinal axis of the container. The system detects signals generated by the container in response to electrons being released within the container as a result of atoms of the inert gas being ionized by gamma ray radiation and then traveling to the anode.

### CROSS REFERENCE TO RELATED APPLICATIONS

This application claims the benefit of U.S. Provisional Application No. 60/883,250, filed Jan. 3, 2007, the contents of which are incorporated herein by reference.

### BACKGROUND OF THE INVENTION

The present invention generally relates to systems and methods for detecting radiation. More particularly, this invention relates to a system and method capable of detecting radiation in a flowing liquid, such as drinking water, and adapted to be placed directly in the flowing liquid.

As the concern for terrorism and nuclear proliferation continues to grow, there is an increasing concern for the risk of intentional contamination of water supplies. The availability of devices capable of detecting threat-level amounts of radioactive contaminants (“radionuclides”) and other hazardous materials in water have therefore become increasingly important. A current radiation contamination standard (Maximum Contaminant Levels, or MCL) used by the Environmental Protection Agency (EPA) of the United States of America and applied to combined radium 226/228 in drinking water is 5×10⁻⁶ micro-curie per liter (μCi/L), equivalent to about 0.185 becquerel per liter (Bq/L).

To date, levels of radiological contamination in water have been measured by taking samples to a laboratory, where the samples are analyzed for gamma-ray emission by highly trained technicians using expensive and complex equipment, such as inductively-coupled plasma atomic emission spectroscopy (ICP-AE) and inductively-coupled plasma mass spectroscopy (ICP-MS). ICP-AE systems with the required sensitivity are expensive, yet are not capable of isotopic identification. ICP-MS systems are capable of isotopic identification, but at the required sensitivity cost even more ICP-AE systems. Aside from costs, there is a need for systems capable of rapidly detecting radiation in water at the above-noted EPA standards level in a relatively short amount of time, for example, measured in hours instead of days. While existing ICP-AE and ICP-MS technologies are technically capable of rapidly detecting and identifying radiation, the cost of such a system is not practical for widespread use. For this reason, present commercial systems relyon semiconductor- or scintillator-based technologies, which though less sensitive are commercially available at a lower cost than current ICP-AE and ICP-MS systems. An example is the ORTEC® OS5500 water monitoring system, commercially available from Advanced Measurement Technology, Inc., which utilizes a 3×3 inch (about 7.6×7.6 cm) thallium-activated sodium iodide (NaI(TI)) gamma scintillation detector. This system is computer controlled and displays the measured gamma spectrum and radionuclei concentration by isotopes. Even though less expensive than current ICP-AE and ICP-MS systems, monitoring systems of this type can still be cost prohibitive for may applications. Furthermore, the OS5500 system is limited to detecting radiation in water at a level of about 1.3×10⁻⁴ μCi/L for Cs¹³⁷ in one hour, which is about two orders of magnitude higher than the EPA standard of 5×10⁻⁶ μCi/L.

In view of the above, there is a need for a more affordable radiation detection system that can rapidly detect and measure the intensity of radioactive isotopes in a liquid, and particularly a flowing liquid as is present in a water supply system.

### BRIEF SUMMARY OF THE INVENTION

The present invention provides a relatively inexpensive system and method capable of real-time detection of radiation in a liquid, such as flowing water within a water supply system.

According to a first aspect of the invention, the system includes a closed tubular-shaped container having a hollow interior that contains an inert gas at an elevated pressure, and a tubular-shaped housing surrounding the container. The container has a wall structure comprising a cathode, and an inner electrical element is disposed within the interior of the container and defines an anode along a longitudinal axis of the container. The housing has an inlet at a first end thereof and an outlet at an oppositely-disposed second end thereof, and the container and housing cooperate to define a flow passage therebetween that is generally parallel to the longitudinal axis of the container. The system detects signals generated by the container in response to electrons being released within the container as a result of atoms of the inert gas being ionized by gamma ray radiation and then traveling to the anode.

According to a second aspect of the invention, the method includes flowing a liquid through a flow passage defined by and between a closed tubular-shaped container surrounded by a tubular-shaped housing. The container has a hollow interior that contains an inert gas at an elevated pressure, a wall structure comprising a cathode, and an inner electrical element disposed within the hollow interior of the container and defining an anode along a longitudinal axis of the container. The housing has an inlet at a first end thereof and an outlet at an oppositely-disposed second end thereof so that the flow passage is generally parallel to the longitudinal axis of the container. The method then entails detecting signals generated by the container in response to electrons being released within the container as a result of atoms of the inert gas being ionized by gamma ray radiation and then traveling to the anode.

In view of the above, it can be seen that a significant advantage of this invention is that the system is adapted to detect radiation in a flowing liquid, such as water flowing in a municipal water system, by coupling the housing to a water-carrying conduit such that the gas-filled container is directly located in the flowing liquid. According to a preferred aspect of the invention, the container is capable of withstanding the pressure of a flowing liquid and can be designed to cause a minimal pressure drop in the flowing liquid.

According to other preferred aspects of the invention, the system is well suited for use in detecting sources of radiation that may be present in a water supply system due to intentional or accidental contamination. The system is preferably capable of remotely and rapidly detecting radiation within a water supply, and then alerting users of high levels of radiation within the water supply. The sensitivity of the system is dependent on integration time, which may be, for example, one minute, ten minutes, one hundred minutes, etc. The system is simple and much more affordable than presently available devices, and can make measurements within one hour that are about five to twenty times less sensitive than current EPA standards—a level of sensitivity that is significantly better than commercially available detections systems. By increasing the integration time, the sensitivity of the system gets closer to EPA standards. As such, the system can be employed as a real-time monitor for public drinking water systems for compliance with EPA drinking water radiation standards. The system can function on a stand-alone basis or can be integrated into a multi-parametric water quality monitoring system for water utilities, military installations, schools, hotels, embassies, and other facilities of interest.

The fields of environmental science and hydrogeology would also benefit from the availability of a network of water quality monitoring points that can be established with the system of this invention. In combination with weather records, groundwater and surface water chemistry, and historical information, databases can be developed and analyzed to reveal correlations between such parameters as groundwater chemistry, weather, geology, and levels and types of dissolved radiation.

Other objects and advantages of this invention will be better appreciated from the following detailed description.

### BRIEF DESCRIPTION OF THE DRAWINGS

FIG. 1 is a perspective sectional view of a radiation detection system equipped with a Geiger-Müller tube within a tubular housing in accordance with a preferred embodiment of this invention.

FIG. 2 is a block diagram of counting electronics for use with the system of FIG. 1.

FIG. 3 schematically represents the geometry of the radiation detection system of FIG. 1.

FIG. 4 is a graph representing the probability of interaction between gamma rays and inert gas atoms within the tube of FIG. 1 per tube volume unit as a function of gamma-ray energy.

FIG. 5 is a graph representing the dependence of an observed signal as a function of the radius of the housing of FIG. 1.

FIG. 6 is a graph representing free mean paths of gamma rays in water as a function of gamma ray energy.

FIG. 7 is a graph representing the typical behavior of the total observed signal obtained with the system as a function of the length of the tube for three different gamma ray energy levels.

FIG. 8 is a graph representing the predicted count rate in a xenon-filled tube as a function of gamma ray energy per hour of integration time, based on a tube length of one centimeter and a radioactive material concentration of 1×10⁻¹⁰ Ci/L.

### DETAILED DESCRIPTION OF THE INVENTION

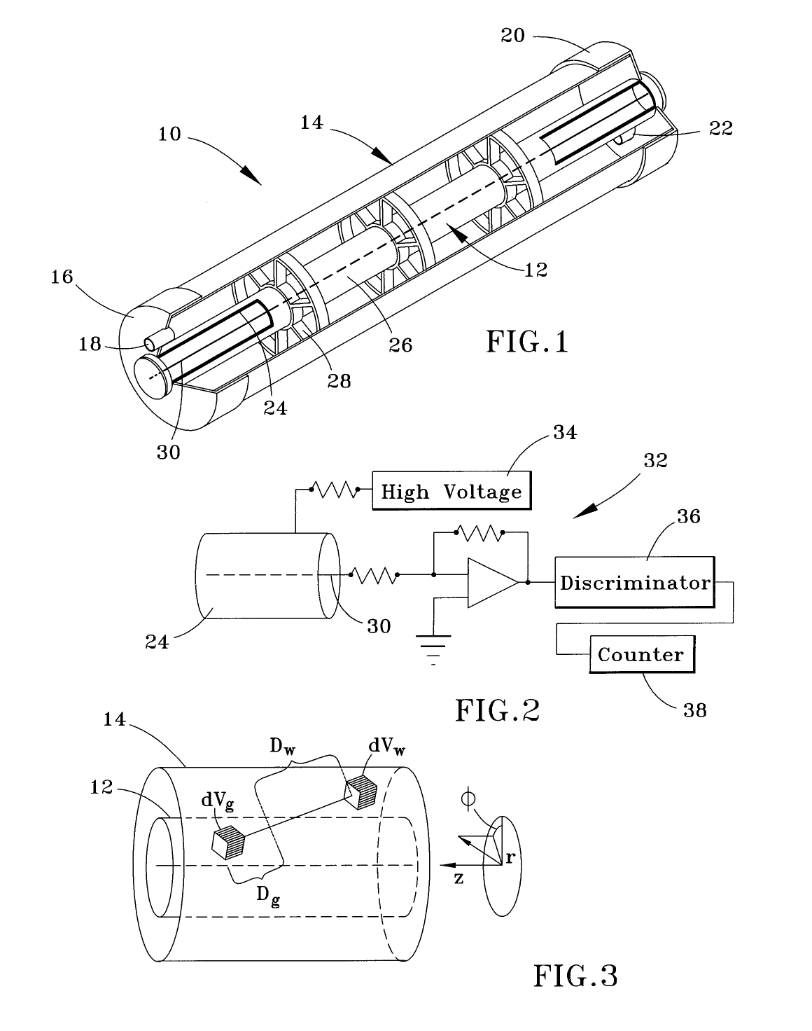

FIG. 1 schematically represents a radiation detection system 10 in accordance with a nonlimiting embodiment the present invention. The system 10 operates on the basis of inert gas technology, instead of ICP-AE, ICP-MS, semiconductor-based, and scintillator-based technologies of the prior art. The inert gas-based technology employed by this invention has the capability of greatly lowering the cost of production and replacement of the system 10 as compared to existing systems, allowing the system 10 to be more widely deployed.

As represented in FIG. 1, the detection system 10 is adapted for sensing radiation in a liquid, such as water flowing in a municipal water supply system. The system 10 includes a tubular-shaped container in the form of a Geiger-Müller (GM) tube 12 coaxially disposed within an outer tubular-shaped housing 14. Together, the tube 12 and its housing 14 define an annular-shaped flow passage therebetween that is generally parallel to the shared longitudinal axis of the tube 12 and housing 14. The tube 12 and housing 14 are shown and described as having tubular shapes, though the term “tubular” as used herein is not limited to tubular shapes with circular or round cross-sections, in that other cross-sectional shapes are also encompassed by this term and the invention. Water enters a first end 16 of the tube housing 14 through an inlet opening 18, flows over and around the outer wall of the GM tube 12, and exits the tube housing 14 through an outlet opening 22 at its opposite end 20. As represented in FIG. 1, the inlet and outlet openings 18 and 22 are not axially aligned, but instead are axially offset to promote flow around the GM tube 12. The ends 16 and 20 of the housing 14 can have suitable couplings (not shown) or otherwise configured to enable the housing 14 to be installed in an existing conduit through which water flows.

As will become apparent from the following discussion, the operative length of the system 10, as defined by the length of the GM tube 12, and the width of the flow passage within the housing 14, as defined by the distance between the tube 12 and housing 14 in any direction intersecting and perpendicular to the longitudinal axes of the tube 12 and housing 14, are important factors in the performance of the system 10. For example, the radii of the tube 12 and housing 14 are preferably constant and the tube 12 is preferably centrally located within the housing 14 so that the distance between the tube 12 and housing 14 is substantially constant along the entire length of the tube 12.

The GM tube 12 is filled with an inert gas at an elevated pressure. The inert gas is preferably xenon at a pressure of up to about ten atmospheres, though it is within the scope of this invention to use different inert gases (e.g., argon) at a variety of pressures. The GM tube 12 is preferably constructed so that a single filling of inert gas is sufficient to last the design lifetime of the tube 12. Furthermore, the GM tube 12 preferably has a wall structure that includes an inner electrically-conductive wall 24 contacted by the inert gas, and a support wall 26 that entirely surrounds and preferably encases the conductive wall 24. The conductive wall 24 serves as a cathode of the GM tube 12, while the support wall 26 provides mechanical support and strength for the conductive wall 24. The conductive wall 24 is preferably sufficiently thin to enable gamma rays to pass through the wall structure of the GM tube 12 with little attenuation. To inhibit corrosion and promote strength, preferred materials for the conductive wall 24 are stainless steels, though it is foreseeable that other conductive materials could be used. If formed of stainless steel, a suitable thickness for the conductive wall 24 is up to about two mm. The support wall 26 may also include a metal layer, such as a thin metal tube with a plastic coating or a metal-coated plastic material, to reduce gamma ray interactions within the wall structure while providing additional strength, support, and corrosion resistance.

In addition to supporting and strengthening the conductive wall 24 to withstand the gas pressure within the GM tube 12, the support wall 26 also preferably protects the conductive wall 24 from erosion and pressure effects of the flowing water, and preferably also has a sufficiently smooth outer surface to reduce turbulence as the flowing water passes through the system 10. Suitable materials for the support wall 26 are transparent to gamma-ray radiation, for example, plastic materials such as commonly-available polyvinyl chloride (PVC) and cross-linked polyethylene (PEX). FIG. 1 further shows the system 10 as including supports 28 that centrally support the GM tube 12 within the tube housing 14. The supports 28 are represented as comprising two concentric rings connected with radial arms, with the inner ring surrounding and contacting the GM tube 12 and the outer ring contacting the interior surface of the tube housing 14. Other support systems are also within the scope of this invention.

Coaxially disposed within the GM tube 12 is a wire 30 that extends along the longitudinal axis of the tube 12. The wire 30 is at ground potential, and serves as an anode for the cathode defined by the conductive wall 24. A preferred material for the wire 30 is a gold-plated tungsten wire, though it is foreseeable that other materials could be used, such as a stainless steel. With the arrangement shown, any electrons that are released by the inert gas within the GM tube 12 as a result of inert gas atoms being ionized by gamma ray radiation, such as from the decay of radioactive sources within the water, are attracted to the wire (anode) 30 in a direction away from the conductive wall (cathode) 24. The number of electrons thus created can be greatly amplified at the anode wire 30 by operating the tube 12 in the Geiger-Müller mode which, as known in the art, causes breakdown along the entire wire 24, allowing electron gain of between 10⁸ and 10¹⁰.

The system 10 is not required to identify the radionuclide responsible for the source of the radiation, but needs only to report that a radionuclide is present in the water. In this manner, the system 10 is capable of providing a warning or trigger that the water flowing through the tube housing 14 is contaminated. Importantly, the system 10 is also capable of exhibiting sensitivities of a factor of ten or more greater than commercial systems using ICP-AE, ICP-MS, semiconductor-based, and scintillator-based technologies.

A notable advantage of the GM tube 12 employed by this invention is the ability to use a simple counting system for detecting the signals generated by the tube 12 in response to electrons traveling to the anode wire 30 after being released within the tube 12 as a result of gas atoms within the tube 12 becoming ionized by gamma ray radiation. A suitable counting system 32 for this purpose is schematically represented in FIG. 2. The radiation detection system 10 and its counting system 32 can be operated without the illustrated preamplifier due to the very large gain of the GM tube 12. If the conductive wall (cathode) 24 of the GM tube 12 is held at a sufficiently high voltage, e.g., several thousand volts, supplied by a power supply 34, the counting system 32 does not require a high voltage blocking capacitor since the tube 12 itself serves to “block” the high voltage from the counting system 32. The series resistance Rs between the power supply 34 and the conductive wall 24 serves to limit current to the tube 12 in case the wire 30 breaks. Because the tube 12 is only required to count gamma ray interaction events, the counting system 32 can be uncomplicated and does not require complex signal processing or off-line signal analysis. Instead, after passing through a discriminator 36, the output goes to a counter 38 and, if so desired, to a computer or other device (not shown) for integrating the detected signals over a desired period of time, for example, up to an hour or more.

The sensitivity of the system 10 represented in FIGS. 1 and 2 can be predicted in accordance with the following discussion, which is in reference to the geometry, coordinate system, and nomenclature represented in FIG. 3. The geometry of the system 10 is represented in FIG. 3 as defining two volumes, dV_{w} and dV_{g}, which correspond to, respectively, water volume elements within the tube housing 14 and gas (detector) volume elements within the GM tube 12. For a given concentration of radioactive material in the water, C, the number of particles that are emitted from the water volume element dV_{w} with coordinate r_{w}, reach the gas volume element dV_{g} with coordinate r_{g}, and are detected in this volume element, can be calculated as:

CdV_{w}/D²_{w,g}×Tₘₑₐₛᵤᵣₑₘₑₙₜ×exp[−D_{w}/λ_{w}(E_{γ})]×[1−exp(−D_{g}/λ_{g}(E_{γ}))]×Σᵢₙₜ (1)

where D_{w,g} is the distance between the water volume element dV_{w} and the gas volume element dV_{g} (D_{w,g} is a function of the coordinates of the dV_{w} and dV_{g}), Tₘₑₐₛᵤᵣₑₘₑₙₜ is the integration time, D_{w} is that part of the distance D_{w,g} over which a gamma ray travels in the water to reach dV_{g}, D_{g} is that part of the distance D_{w,g} over which a gamma ray travels in the gas. D_{w} and D_{g} are therefore dependent on the positions of dV_{w} and dV_{g}. If the coordinate of the point on the surface of the GM tube 12 at which the gamma ray emitted from water volume element dV_{w} enters the gas volume element dV_{g} is designated r_{d}, then D_{w} and D_{g} can be expressed as:

D_{w}=|r_{w}−r_{d}|

D_{g}=|r_{g}−r_{d}|

The attenuation length of gamma rays in the water is λ_{w}(E_{γ}), and the attenuation length of gamma rays in the gas within the tube 12 is λ_{g}(E_{γ}). Both attenuation lengths depend on the energy of the gamma rays.

The first exponential factor in equation (1) is exp(−D_{w}/λ_{w}(E_{γ})), and represents the probability of absorption of the gamma ray in the water before it reaches dV_{g}. The second exponential factor in equation (1) is [1−exp(−D_{g}/λ_{g}(E_{γ}))], and represents the probability that the gamma ray does not interact with the gas within the GM tube 12 until it reaches volume element dV_{g}. Finally, Σᵢₙₜ represents the total cross-section of the gamma ray interaction within the volume dV_{g}.

For the gas volume element dV_{g}, the thin volume approximation in which it is assumed that none of the electrons are shadowed by other electrons within the volume, is sufficient. Therefore each gamma ray has equal probability to interact with all gas particles in dV_{g}. The total cross-section due to Compton scattering of the gamma ray interaction with this volume is:

Σᵢₙₜ(E_{γ})≈σ_{Compton}(E_{γ})N_{electrons≈σ}_{Compton}(E_{γ})×Z_{gas}×(N_{AV}×ρ_{STP})/A_{gas}×(P/P_{STP})×dV_{g} (2)

where σ_{Compton} is the energy dependent Compton cross-section, Z_{gas} is the number of electrons per gas atom, N_{AV} is Avogadro's number, ρ_{STP} is the density of the gas within the GM tube 12 at the standard temperature and pressure conditions, A_{gas} is the atomic number of the gas, P is the gas pressure in the tube 12, and P_{STP} is one atmosphere. Total Compton cross-section per electron can be written in the form:

σ_{Compton}=πrₒ²/α{[1−2(α+1)/α²] ln(2α+1)+1/2+4/α−1/2(α+1)²}

where α=E_{γ}/mc²
and rₒ=e²/4πεₒmc²=2.818 femtometers is the constant.

Integration of equation (1) over the total volume of water (V_{w}) and over the total volume of the GM tube 12 (V_{GM}) yields the total expected signal, S_{observed} for a given gamma ray energy:

S_{observed}(E_{γ})=∫_{V}_{_{GM∫}}_{V}_{_{w}}CdV_{w}/|r_{w}−r_{g}|×Tₘₑₐₛᵤᵣₑₘₑₙₜ×exp[−|r_{w}−r_{d}|/λ_{w}(E_{γ})]×[1−exp(|r_{g}−r_{d}|/λ_{g}(E_{γ}))]×Σᵢₙₜ(E_{γ}) (3)

Distances between the water volume element dV_{w}, the gas volume element dV_{g}, and the point on the surface of the GM tube 12 with coordinate r_{d} can be written in cylindrical coordinate system as:

|r_{w}−r_{g}|={(r_{w}²+r_{g}²−2 cos(φ_{w}−φ_{g}))+(h_{w}−h_{g})²}¹/2

|r_{w}−r_{d}|={(r_{w}²+r_{d}²−2 cos(φ_{w}−φ_{d}))+(h_{w}−h_{d})²}^{1/2}

|r_{g}−r_{d}|={(r_{g}²+r_{d}²−2 cos(φ_{g}−φ_{d}))+(h_{g}−h_{d})²}^{1/2}

where (r_{w}, φ_{w}, h_{w}) are the cylindrical coordinates of the water volume element dV_{w}, (r_{g}, φ_{g}, h_{g}) are the cylindrical coordinates of the gas volume element dV_{g}, and (r_{d}, φ_{d}, h_{d}) are the cylindrical coordinates of the point on the surface of the GM tube 12 where the gamma ray enters the volume of the tube 12. Therefore, the total observed signal of the spectrum of the radiation emitted from water, f(E_{γ}) is

Sₜₒₜₐₗ=∫_{E}f(E_{γ})·S_{observed}(E_{γ})dE_{γ} (4)

For a gamma source that emits gamma rays with discrete energies, the gamma energy spectrum can be expressed in the form:

f(E_{γ})=Σᵢδ(E_{γ}−Eᵢ)

where Eᵢ is the energy of the gamma line in the spectrum. In this case, the total observed spectrum can be expressed in a very simple form:

Sₜₒₜₐₗ=∫_{Eγ}[Σᵢδ(E_{γ}−Eᵢ)]·S_{observed}(E_{γ})dE_{γ}=ΣᵢS_{observed}(Eᵢ) (5)

For example, a Cs¹³⁷ gamma source emits gamma rays with the single energy of 667 keV. In this case, the total observed signal can be calculated as S_{Total}^{Cs137}=S_{observed}(667 keV). For gamma sources with a pseudo-continuous gamma spectrum, such as Cf²⁵² or other fission materials, the total cross-section can be calculated by using (4).

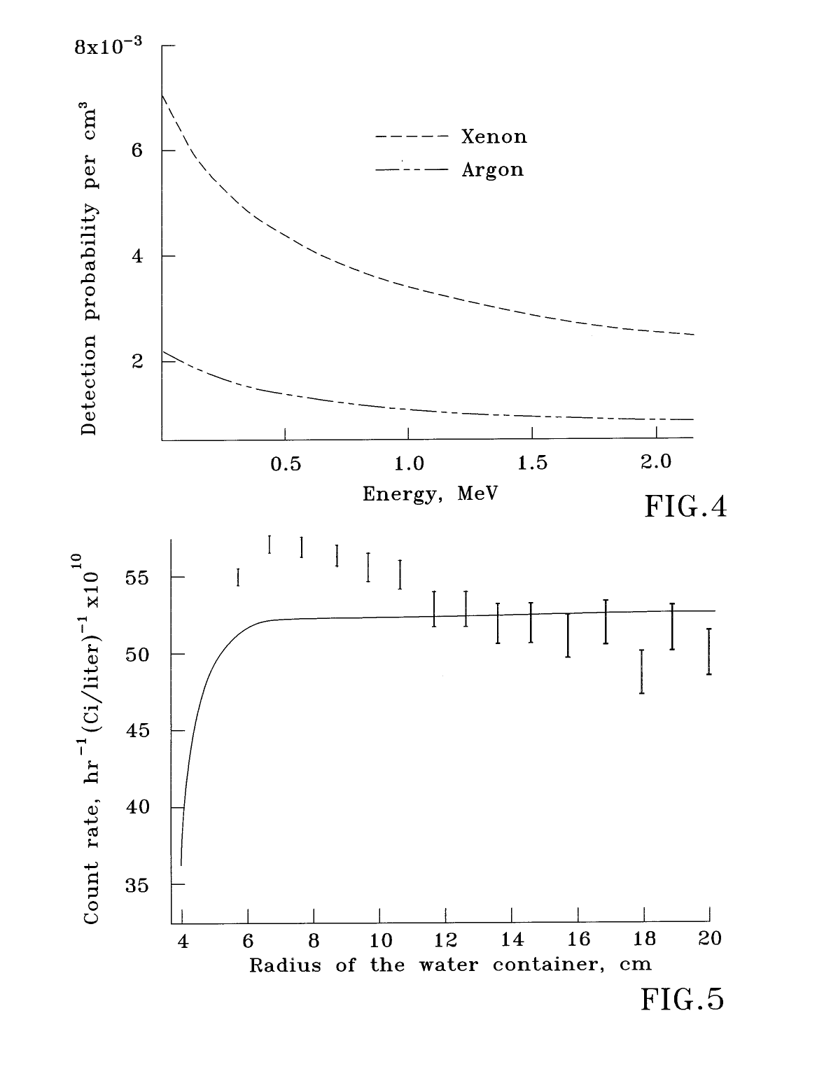

Since the total observed signal depends on the Z number of the gas used in the GM tube 12, xenon (Z=54) is preferred as the fill gas for the tube 12 rather than argon (Z=18) or another lower-Z number inert gas. The probabilities of interaction between gamma rays with xenon and argon gas atoms per gas volume element are shown in FIG. 4. In the energy range from 100 keV to 2 MeV, it can be seen from FIG. 4 that the probability of detecting gamma rays in a xenon-filled GM tube 12 is approximately three times higher than in an argon-filled tube 12.

In order to find the dependence of the observed signal on the length of the detection system 10, the radius of the tube housing 14, and the energy of the gamma rays emitted by the water and entering the GM tube 12, the total signal (equation 3) was calculated numerically. The dependence of the observed signal as a function of the radius of the tube housing 14 is represented in FIG. 5. The signal was calculated based on the length of the detection system 10 being twenty centimeters and the energy of the gamma rays being 0.5 MeV. The total observed signal can be seen to increase linearly with the radius of the tube housing 14, i.e., the GM tube 12 collects gamma rays from the entire water volume within the housing 14. However, gamma rays will be eventually attenuated by the water as the distance increases between the tube 12 and the water volume elements that are the source of the rays. Therefore, the radius of the housing 14 (and therefore the radial distance between the tube 12 and the housing 14) has a limit at which the gamma attenuation factor of the water should be taken into account, and it can be expected that the total signal dependence on the radius of the water volume will have a saturation point. The observed signal dependence on the radius of the housing 14 was calculated for different gamma ray energies, from which it was determined that a radius of about twenty centimeters for the housing 14 is sufficient to assure that the GM tube 12 collects gamma rays from the entire water volume within the housing 14.

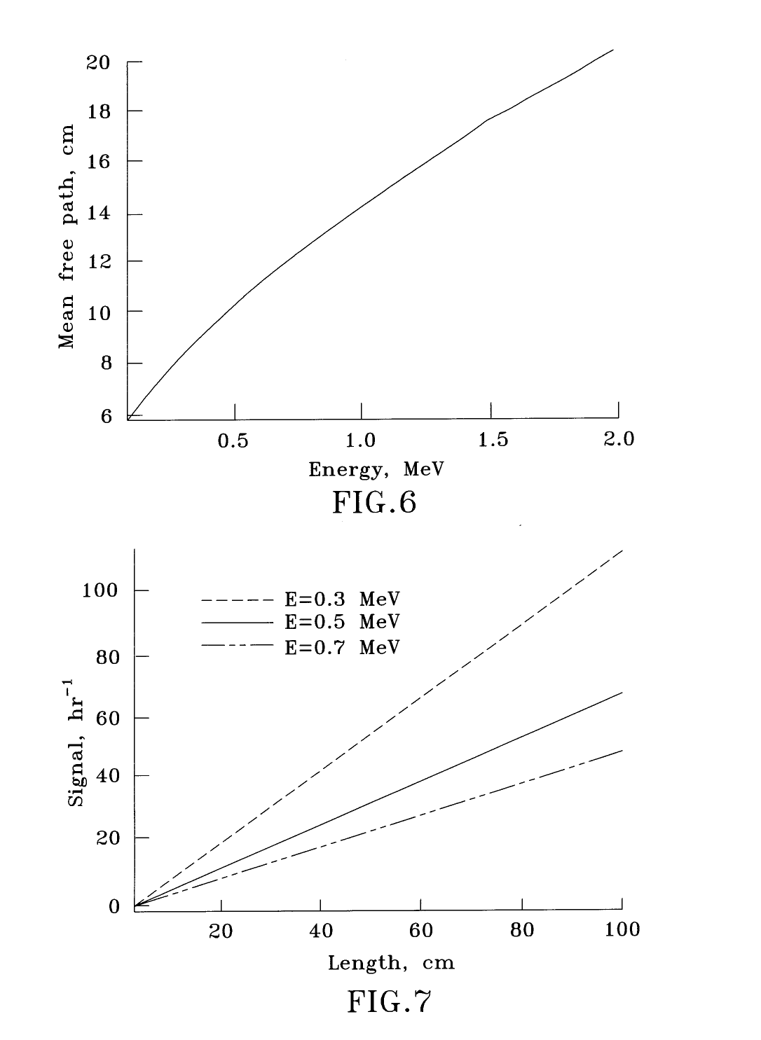

Another important feature of the water volume is its shielding ability. The tube housing 14 serves as a shield, protecting the gas-filled GM tube 12 from environmental gamma radiation. Free mean paths of the gamma rays in water as a function of the gamma ray energy are shown in FIG. 6, which shows that, for gamma rays naturally occurring in the environment with energies in the range of about 100 keV to about 1.5 MeV, twenty centimeters of water is able to attenuate the gamma rays by a factor of about 0.05 to about 0.3. The gamma rays naturally occurring in the environment are emitted in all directions and therefore, on average, will travel through more than twenty centimeters of water before they reach the GM tube 12.

Typical behavior of the total observed signal as a function of the GM tube 12 for gamma rays at three different energy levels is shown in FIG. 7. The signals were calculated based on a radioactive material concentration of about 10⁻¹⁰ Ci/L in water. The radius of the xenon-filled tube 12 is three centimeters, and the radius of the housing 14 is twenty centimeters, providing a radial distance therebetween of seventeen centimeters.

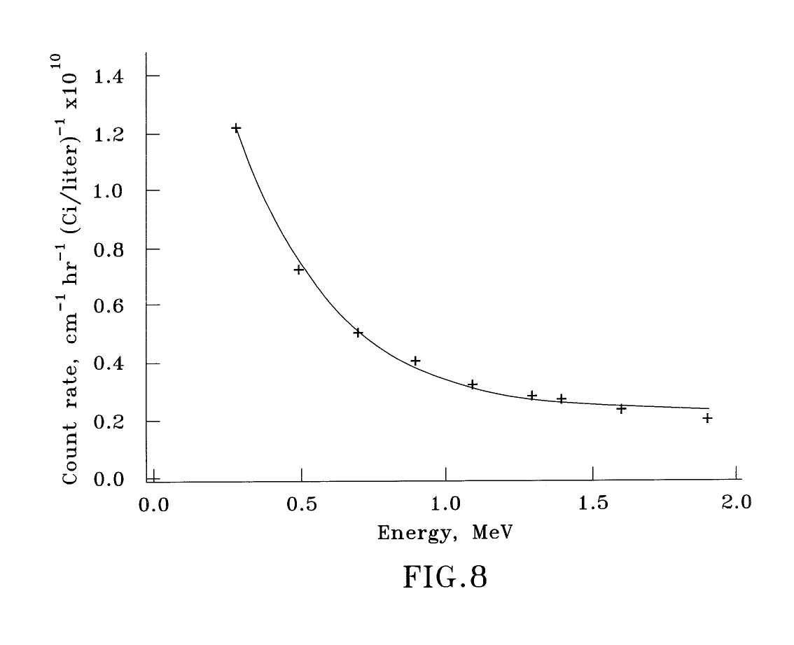

The predicted efficiency for the GM tube 12 filled with xenon is plotted for different gamma ray energy levels in FIG. 8. The data are for a tube 12 with a radius of about three centimeters, and calculated for a one centimeter unit length, one-hour integration time, and a radioactive material concentration of 1 Ci/L in water. Predicted count rate in xenon filled detector as a function of the gamma rays energy per hour of integration time, 1 cm of the system length and concentration of radioactive material in Ci/L. The calculated function in FIG. 8 enables the total observed signal in the GM tube 12 to be estimated. For example, the efficiency of the tube 12 for detecting Cs¹³⁷, which emits gamma rays with the energy 667 keV, is approximately 0.5 counts per one-centimeter length of the tube 12 per hour of integration time per concentration in water of 10⁻¹⁰ Ci/L.

Based on the count rate dependence on energy of the gamma ray, the observed number of counts can be predicted for a given time of measurement. For example, for Cs¹³⁷ dissolved in water at concentration level of 10⁻¹⁰ Ci/L, observed counts in a xenon-filled GM tube 12 with a length of about 100 cm will be approximately 50 counts per hour.

On the basis of equation (1), the performance of the radiation detection system 10 represented in FIG. 1 is determined by the following parameters: length of the GM tube 12; radius of the tube housing 14; the energy of the observed gamma rays; and the integration time over which measurements are obtained. Suitable dimensions for the GM tube 12 are a length and uniform radius of, for example, about 100 cm and about 3 cm, respectively. The dimensions of the tube 12 as well as the housing 14 can vary widely to accommodate the physical requirements of the specific water flow system. As previously noted, because gamma rays can be attenuated by the water as the distance increases between the tube 12 and the water volume elements that are the source of the rays, the radii of the tube 12 and housing 14 are preferably constant and the tube 12 is preferably centrally located within the housing 14 so that the radial distance between the tube 12 and housing 14 is substantially constant along the entire length of the tube 12. Otherwise, it should be noted that the sizes of the tube 12 and housing 14, integration time, and the volume of the housing 14 are limited only by practical considerations and customer requirements.

Based on the foregoing analysis, it was concluded that the radiation detection system 10 represented in FIG. 1 with its GM tube 12 filled with xenon at pressures of up to about ten atmospheres should be capable of detecting, in about one hour, the presence of radioactive isotopes in water flowing through the housing 14 at a level of about 10⁻¹⁰ to about 10⁻¹¹ Ci/L, which is only ten to one hundred times higher than the present EPA contamination standard of 5×10⁻¹² Ci/L. As such, the system 10 as analyzed is at least comparable if not superior to existing radiation detection systems, while being significantly less expensive. The calculated dependence of the efficiency of the detection system 10 as a function of the energy of the gamma rays enables the total observed signals/counts to be predicted for a given integration time signal from any radioisotopes with continuous as well as discrete energy spectra.

While the invention has been described in terms of a preferred embodiment, it is apparent that other forms could be adopted by one skilled in the art. For example, the physical configuration of the system 10 could differ from that shown, and materials and processes other than those noted could be used. Therefore, the scope of the invention is to be limited only by the following claims.

1. A system for detecting radiation in a flowing liquid, the system comprising:
a closed tubular-shaped container having a hollow interior that contains an inert gas at an elevated pressure, a wall structure comprising a cathode, and an inner electrical element disposed within the hollow interior and defining an anode along a longitudinal axis of the container;
a tubular-shaped housing surrounding the container, the housing having an inlet at a first end thereof and an outlet at an oppositely-disposed second end thereof, the container and housing cooperating to define a flow passage generally parallel to the longitudinal axis of the container; and
means for detecting signals generated by the container in response to electrons being released within the container as a result of atoms of the inert gas being ionized by gamma ray radiation and then traveling to the anode.

2. The system according to claim 1, wherein the cathode of the wall structure of the container comprises a conductive wall formed of a stainless steel.

3. The system according to claim 2, wherein the wall structure of the container further comprises a support wall that covers the conductive wall and is formed of a material that is transparent to gamma radiation.

4. The system according to claim 1, wherein the wall structure of the container further comprises a support wall that covers the cathode and is formed of a material that is transparent to gamma radiation.

5. The system according to claim 1, wherein the inert gas is xenon or argon.

6. The system according to claim 1, wherein the elevated pressure of the inert gas is up to about 10 atmospheres.

7. The system according to claim 1, wherein the inner electrical element is completely circumscribed by the cathode.

8. The system according to claim 1, wherein the inner electrical element is formed of a gold-plated tungsten wire.

9. The system according to claim 1, wherein the container and the housing have a substantially constant radial distance therebetween.

10. The system according to claim 1, further comprising a liquid flowing through the flow passage.

11. The system according to claim 10, wherein the system is operable to detect the presence of radioactive isotopes at a level of at least 10⁻¹¹ Ci/liter in the liquid flowing through the flow passage.

12. The system according to claim 10, wherein the liquid is water of a municipal water supply.

13. The system according to claim 1, further comprising means for integrating the detected signals over a duration of up to an hour.

14. A method of detecting radiation in a flowing liquid, the method comprising:
flowing the liquid through a flow passage defined by and between a closed tubular-shaped container surrounded by a tubular-shaped housing, the container having a hollow interior that contains an inert gas at an elevated pressure, a wall structure comprising a cathode, and an inner electrical element within the hollow interior and defining an anode along a longitudinal axis of the container, the housing having an inlet at a first end thereof and an outlet at an oppositely-disposed second end thereof so that the flow passage is generally parallel to the longitudinal axis of the container; and
detecting signals generated by the container in response to electrons being released within the container as a result of atoms of the inert gas being ionized by gamma ray radiation and then traveling to the anode.

15. The method according to claim 14, wherein the inert gas is xenon or argon.

16. The method according to claim 14, further comprising integrating the detected signals over a duration of up to an hour.

17. The method according to claim 14, wherein the method detects the presence of radioactive isotopes at a level of at least 10⁻¹¹ Ci/liter in the liquid flowing through the flow passage.

18. The method according to claim 14, wherein the liquid is water of a municipal water supply.
